(19) United States
(12) Patent Application Publication
(10) Pub. No.: US 2026/0079953 A1
(43) Pub. Date: Mar. 19, 2026

(54) SYSTEM AND METHOD FOR GENERATING VISUALIZATION FROM STRUCTURED DATA

(71) Applicant: Quantiphi, Inc, Marlborough, MA (US)

(72) Inventors: Dagnachew Birru, Marlborough, MA (US); Ankit Prakash, Mumbai (IN); Ayush Dudhe, Mumbai (IN); Sriram Natarajan, Mumbai (IN); Ashwin Sanjeevan, Mumbai (IN)

(21) Appl. No.: 18/888,930

(22) Filed: Sep. 18, 2024

(51) Int. Cl. G06F 16/248; G06F 16/2452

(52) U.S. Cl. CPC G06F 16/248; G06F 16/24522

(57) ABSTRACT

Disclosed is system (100) for generating visualizations from structured data (SD) queried through natural language. The system comprising processor (102) communicably coupled to user device (UD) (104), configured to: receive partially unstructured data query from UD and generate corresponding SD query; execute generated structured data query (SDQ) to generate SD comprising one or more datapoints; receive and analyze SD according to one statistical principle; when analyzed SD comprises plurality of datapoints (POD), generate visualization recommendation (VR) based on generated POD; or when analyzed SD comprises single datapoint, generate at least one alternative SDQ corresponding to one of: partially unstructured data query, SD query, execute generated at least one alternative SDQ to generate alternative SD comprising one or more datapoints, analyze alternative SD according to one statistical principle, and when analyzed alternative SD comprises POD, generate VR based on generated POD; and present, at UD, generated VR to user.

### FIELD OF TECHNOLOGY

The present disclosure generally relates to visualization representation of data. Specifically, the present disclosure relates to a system and a method for generating visualizations from structured data queried through natural language and non-transitory computer-readable storage mediums.

### BACKGROUND

In today's data-driven world, the ability to derive meaningful insights from vast amounts of structured data is paramount. Data visualization plays a crucial role in the said process by transforming raw data into graphical representations, making complex information more accessible and understandable. However, creating effective visualizations is not a trivial task, it requires a deep understanding of both the data's content and the appropriate visual representation techniques. The aforementioned complexity poses a significant challenge, particularly for users who lack specialized knowledge in the data visualization and analysis, leading to a growing demand for automated solutions that can bridge this expertise gap and facilitate the extraction of valuable insights from data.

Existing solutions to address the problem of data visualization leverage automation of visualizations, that aim to automate the visualization creation process to address the aforementioned challenges. The existing solutions operate in either a fully automated mode, where said solutions autonomously generate relevant visualizations, or a semi-automated mode, where users specify their goals and said solutions generate visualizations accordingly. Moreover, approaches to the automation include heuristics-based methods that explore data properties to create and rank potential visualizations, and learning-based methods that use patterns learned from large datasets. However, the existing solutions often fall short in providing tailored and meaningful visual representations, especially when handling diverse and complex datasets.

Existing solutions also offer visualization capabilities based on user queries but have certain limitations. The existing tools frequently generate visualizations that are either irrelevant or uninformative, particularly when dealing with sparse data that does not naturally lend itself to graphical representation. Moreover, other advanced tools leverage large language models (LLMs) to create data visualizations and infographics. However, LIDA does not integrate well-grounded statistical principles and are limited to single structured files, failing to handle more complex queries that span multiple tables.

Therefore, in light of the foregoing discussion, there exists a need to overcome the aforementioned drawbacks.

### BRIEF SUMMARY OF THE DISCLOSURE

The present disclosure provides a system and a method to ensure generation of visualizations based on user queries across multiple structured documents instead of operating on entire datasets. The present disclosure seeks to provide a solution to the existing problem of how to simplify and automate a process of generating visualizations for unstructured user queries. The aim of the present disclosure is to provide a solution that overcomes at least partially the problems encountered in the prior art and provide an improved system and method for generating visualizations of structured data queried through natural language. The aim of the present disclosure is achieved by a system and a method for generating visualizations using at least one statistical principle, such as Edward Tufte's principles of Graphical integrity, and Large Language Model (LLM) for visualization recommendation.

In one aspect, the present disclosure provides a system for generating visualizations from structured data queried through natural language. The system comprises a processor, which is communicably coupled to a user device. The processor is configured to receive at least partially unstructured data query from the user device and generate a corresponding structured data query thereto. Moreover, the processor is configured to execute the generated structured data query to generate structured data comprising one or more datapoints. Furthermore, the processor is configured to receive the structured data and analyze the structured data according to at least one statistical principle. Furthermore, the processor is configured to generate a visualization recommendation based on the generated plurality of datapoints, when the analyzed structured data comprises a plurality of datapoints. Furthermore, when the analyzed structured data comprises a single datapoint, the processor is configured to generate at least one alternative structured data query corresponding to the at least one of at least partially unstructured data query, the structured data query. Furthermore, the processor is configured to execute the generated at least one alternative structured data query to generate a corresponding alternative structured data comprising one or more datapoints. Furthermore, the processor is configured to analyze the alternative structured data according to at least one statistical principle. Furthermore, the processor is configured to generate a visualization recommendation based on the generated plurality of datapoints, when the analyzed alternative structured data comprises a plurality of datapoints. Furthermore, the processor is configured to present, at the user device, the generated visualization recommendation to the user.

Beneficially, the embodiments of the present disclosure provide a simplified, efficient and automated system that ensures statistical integrity by adhering to the Edward Tufte's principles of graphical integrity which enhances accuracy and reliability of the visualizations. The system automates the process of data analysis by executing structured queries and reduces the time and effort required for manual data analysis and minimizes errors. The use of structured data, queried through natural language provides query-based flexibility and provides scalable and adaptable data analysis. Moreover, use of Natural Language Processing (NLP) allows the user to input queries in their own words and make the system more user-friendly. Furthermore, the disclosed system significantly increases a speed of generating the visualizations for the unstructured data input by the user. Furthermore, use of the at least one statistical principle facilitates the generation of a well-structured query on the basis of the unstructured query input by the user and reduce the gap between user intent and machine-understandable commands.

In another aspect, the present disclosure provides a method for generating visualizations from structured data queried through natural language. The method comprises receiving at least partially unstructured data query and generating a corresponding structured data query thereto. Moreover, the method comprises executing the generated structured data query to generate structured data comprising one or more datapoints. Furthermore, the method comprises receiving the structured data and analyzing the structured data according to at least one statistical principle. Furthermore, the method comprises, when the analyzed structured data comprises a plurality of datapoints, generating a visualization recommendation based on the generated plurality of datapoints. Furthermore, alternatively, the method comprises, when the analyzed structured data comprises a single datapoint, generating at least one alternative structured data query corresponding to the at least one of: at least partially unstructured data query, the structured data query. Moreover, the method comprises executing the generated at least one alternative structured data query to generate a corresponding alternative structured data comprising one or more datapoints. Furthermore, the method comprises analyzing the alternative structured data according to at least one statistical principle. Furthermore, the method comprises when the analyzed alternative structured data comprises a plurality of datapoints, generating a visualization recommendation based on the generated plurality of datapoints. Furthermore, the method comprises presenting, at the user device, the generated visualization recommendation to the user.

The method achieves all the advantages and technical effects of the system of the present disclosure. Herein, the method enables the user to generate visualization plots based on scarce data.

In yet another aspect, the present disclosure provides a non-transitory computer-readable storage medium having computer-readable instructions stored thereon, the computer-readable instructions being executable by a processor to execute the aforementioned method.

The non-transitory computer-readable storage medium achieves all the advantages and technical effects of the system of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not too scaled. Wherever possible, like elements have been indicated by identical numbers.

Embodiments of the present disclosure will now be described, by way of example only, with reference to the following diagrams wherein:

FIG. 1 is a schematic illustration of a system for generating visualizations from structured data queried through natural language, in accordance with an embodiment of the present disclosure;

FIG. 2 is a flowchart of a method for generating visualizations from structured data queried through natural language, in accordance with an embodiment of the present disclosure; and

FIG. 3 is a flowchart depicting of an exemplary scenario of a system for generating visualizations from structured data queried through natural language, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

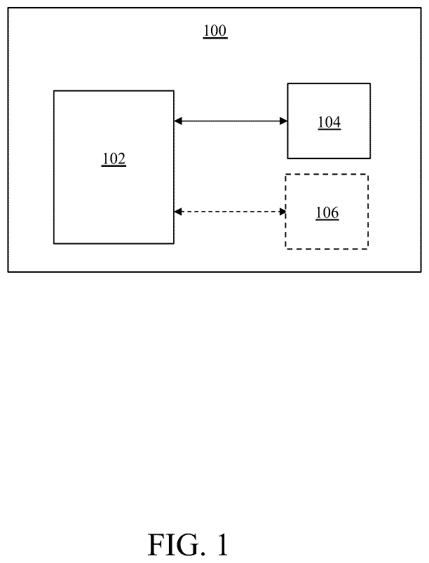

FIG. 1 is a schematic implementation of a system 100 for generating visualization from structured data queried through natural language, in accordance with an embodiment of the present disclosure. As shown in FIG. 1, the system 100 comprises a processor 102 communicably coupled to a user device 104. Herein, the term processor 102 refers to a computational element that is operable to execute the software framework. Examples of the processor 102 include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processor 102 may refer to one or more individual processors, processing devices and various elements associated with a processing device that may be shared by other processing devices. Additionally, one or more individual processors, processing devices and elements are arranged in various architectures for responding to and processing the instructions that execute the software framework. Herein, the term “user device” 104 refers to an electronic device that is utilized by the user to access and interact with the visualizations of the structured data queried through natural language. Typically, the user device 104 may include smartphone, tablet, laptop, and the like. Notably, the processor 102 is communicably coupled to the user device 104.

Throughout the present disclosure, the term “structured data” refers to a data or information that is organized and formatted, such as in a consistent manner. Typically, the structured data is easily searchable and analyzable. The structured data is arranged in rows and columns with clearly defined fields and data types, such as excel files with structured rows and columns. Notably, the structured data is often numeric or text-based, and adheres to a pre-defined schema, allowing for efficient querying and processing. Throughout the present disclosure, the term “natural language” refers to human languages that are naturally spoken or written, such as English, Spanish, Chinese, and the like. Typically, the natural language is an everyday language used by a user to interact with the system 100. Notably, the user interacts with the system 100 by asking questions or making requests in the natural language. For instance, a user might ask, “What are the sales figures for the last quarter?” instead of writing a structured query in a machine-readable language, such as SQL. Moreover, the system 100 employs Natural Language Processing (NLP) techniques to understand, interpret and respond to natural language queries. Furthermore, the NLP involves several subfields such as syntax, semantics and context understanding to parse and process the natural language effectively. Advantageously, natural language queries save time of the user and reduces complexity involved in generating the corresponding structured query, which requires the user to be technically proficient in computer language(s).

The term “visualization” refers to a graphical representation of the structured data queried through the natural language. Typically, the visualizations include transforming the structured data into visual formats like charts, graphs, maps, and infographics, making complex data more accessible, understandable and actionable. Beneficially, visualizations help the user to understand trends, patterns and outliers in the structured data more effectively than raw data tables, that leads to better decision-making and more actionable insights. Furthermore, the processor 102 uses the NLP techniques to interpret and understand the user's natural language queries, that involves parsing the query to identify the intent and the specific data elements being requested. Subsequently, based on the interpreted query, the processor 102 generates a corresponding structured query (such as an SQL query) to retrieve the relevant data from one or more structured data sources. Advantageously, by enabling natural language queries, the system 100 significantly lowers the barrier to data analysis, allowing the user without technical expertise to interact with and interpret complex datasets.

Throughout the present disclosure, the term “partially unstructured data query” refers to a data query that includes elements of both structured data (for example, specific fields, keywords, and the like) and unstructured data (for example, natural language text, free-form queries, and the like). Notably, the system 100 is designed to handle and interpret queries that are not entirely structured. Moreover, the system 100 is capable of understanding and processing queries that include natural language components and potentially vague or ambiguous elements, while still being able to extract and utilize any structured data components in the user input. Furthermore, the system employs the NLP technique to parse and understand the unstructured parts of the at least partially unstructured data query. Advantageously, the at least partially unstructured data query allows the user to formulate queries in a more natural and intuitive way, enhancing the usability of the system.

In an implementation, the at least partially unstructured data query is a user query in natural language. Herein, the term “user query” refers to a request or question posed by the user that seeks information or insights from a data repository 106. Typically, the user query is in natural language. Notably, the user query in natural language allows the user to interact with the system 100 in a straightforward manner and make the system 100 more user friendly. Moreover, the processor 102 employs the NLP techniques to interpret the natural language query to understand the user's intent. A technical effect is that the non-technical users are able to interact with the system 100 using everyday language rather than to learn and use complex query languages.

In an implementation, the at least partially unstructured data query is implemented as multiple structured documents. Herein, the term “multiple structured documents” refers to a collection of well-organized and formatted documents that represent different aspects or components of the at least partially unstructured data query. Notably, the multiple structured documents follow a predefined schema, making the multiple structured documents consistent, predictable and suitable for automated processing and analysis. Moreover, the reason for implementing the at least partially unstructured data query as the multiple structured documents is to enhance data organization and retrieval efficiency. Furthermore, the processor 102 is configured to break down the at least partially unstructured data query into distinct segments or components, each represented as a separate structured document. The implementation allows for handling complex queries that span over various data sources or require multiple steps to answer accurately. Furthermore, the processor 102 parses the at least partially unstructured query to identify the structured and unstructured elements therein. Subsequently, each element of the at least partially unstructured query is mapped to relevant structured data fields across multiple structured documents. For example, a query might refer to multiple tables or datasets, each corresponding to a structured document. The processor 102 then generates structured documents for each identified component, ensuring they conform to a predefined schema. A technical effect is that by implementing the at least partially unstructured data query as the multiple structured documents, the processor 102 can manage large and complex datasets more efficiently. Moreover, each document is structured and indexed, making data retrieval faster and more precise. Additionally, the multiple structured documents improve the system's 100 scalability. As data grows, the multiple structured documents can be distributed and processed in parallel, enhancing performance and responsiveness.

Herein, the term “structured data query” refers to a data query that is generated corresponding to the at least partially unstructured data query. Notably, the at least partially unstructured data query is converted by the processor 102 into the corresponding structured data query that is suitable for precise data retrieval. Moreover, the structured data query is in a formal language such as Structured Query Language (SQL), that is used to interact with relational databases. Furthermore, the processor 102 interprets the natural language components of the at least partially unstructured data query and maps the interpreted components to corresponding database fields and operations. Subsequently, the structured data query is formulated in a precise and formal syntax such as SQL. For example, a user query like “Show me sales for last month” might be transformed into an SQL query (such as SELECT*FROM sales WHERE date >=‘2023-07-01’ AND date <=‘2023-07-31’). Furthermore, the processor 102 receives the at least partially unstructured data query from the user device 104 and employs the NLP techniques to identify key entities, relationships, and intentions within the at least partially unstructured data query. The processor 102 interprets the parsed query elements to recognize the tables, fields and conditions needed to fulfill the at least partially unstructured data query. Based on the interpretation, the processor 102 generates the structured data query that accurately represents the user's request.

Throughout the present disclosure, the term “datapoints” refers to individual units of data that are extracted as a result of executing the generated structured data query. Typically, each data point amongst the one or more datapoints represents a specific piece of information related to the generated structured data query. Notably, the one or more datapoints can be of different types such as numerical datapoints (for example, sales amount, temperature readings, and the like), categorical datapoints (for example, product names, customer ID, and the like), and the like. Moreover, the one or more datapoints are used for generating plots via execution of matplotlib code by the processor 102. In this regard, the datapoints are fetched by running the generated structured data query (namely, SQL) on the data repository 106. The datapoints generated along with visualization recommendation are used to generate the matplotlib code that is used to plot using an open source library, as described below in detail. The term “structured data” refers to a data that is organized in a predefined manner in the form of tables, rows and columns. Typically, the structured data includes one or more datapoints. Notably, the structured data adheres to a specific schema, enabling it to be easily queried, processed and analyzed. Moreover, the purpose of executing the generated structured data query is to transform the user's natural language request into actionable data that can be used for analysis or decision-making. Furthermore, execution of the generated structured data query to generate the structured data comprising one or more datapoints ensures that the user's queries are addressed accurately, and the retrieved data is in a structured format that can be easily utilized.

Throughout the present disclosure, the term “statistical principle” refers to a rule or a principle that is used to collect, analyze, interpret and organize the structured data. It will be appreciated that “at least one statistical principle” refers to “a single statistical principle” in some implementations, and “a plurality of statistical principles” in other implementations. Notably, the purpose of analyzing the structured data according to the at least one statistical principle is to ensure that the structured data is accurately and effectively analyzed to extract meaningful insights. Moreover, the at least one statistical principle establishes a robust foundation for making data-driven decisions, backed by the analysis result of the structured data. Furthermore, the processor 102 applies the at least one statistical principle on the received structured data to reduce errors and to extract significant patterns, trends, and correlations from the received structured data. It will be appreciated that the at least one statistical principle is critical in transforming the at least partially unstructured data query into actionable insights. Merely, retrieving the structured data is often not enough to make informed decisions. By applying the at least one statistical principle, the processor 102 can highlight the relationships within the structured data, enabling more accurate and meaningful interpretations. Furthermore, the statistical processing of the structured data ensures that every dataset returned from an unstructured data query is automatically analyzed based on the at least one statistical principle before recommending any insights.

In an implementation, the at least one statistical principle is selected from at least one of: Edward Tufte's Principles of Graphical Integrity, Grammar of Graphics, etc. Herein, the term “Edward Tufte's principles of Graphical Integrity” refers to a set of principles formulated by Edward Tufte in the field of data visualization. Typically, the Edward Tufte's Principles of Graphical Integrity ensures integrity, clarity, and effectiveness of graphical representations of the received structured data. Moreover, the Edward Tufte's Principles of Graphical Integrity maximizes the data-to-ink ratio by reducing unnecessary graphical elements. Advantageously, the at least one of: Edward Tufte's Principles of Graphical Integrity, etc. ensures that unnecessary and distracting elements, such as outliers, within the received structured data are removed from the received structured data and ensures that the visualizations are accurate, clear and free of distortion. Furthermore, Edward Tufte's Principles of Graphical Integrity employs a clear, detailed and thorough labeling to account for graphical distortion and ambiguity in the data. A technical effect of using the Edward Tufte's Principles of Graphical Integrity is that clear and focused visualizations facilitate the user to quickly grasp the insights without being distracted by extraneous elements. Additionally, reliable and honest visualizations build user trust in the system's 100 output. Notably, the Grammar of Graphics is a framework for understanding and creating visualizations based on many modern data visualization tools and libraries. In the Grammar of Graphics, visualizations are built by combining any combination of elements selected from aesthetics, geometry, scales, coordinate system, faceting, statistical transformations, guides, etc. For example, creating a scatter plot involves mapping data to aesthetics (x and y coordinates), choosing a geometry (points), and possibly adding scales, guides, and a coordinate system. This modular approach allows for complex and customized visualizations by combining and manipulating these elements.

Throughout the present disclosure, the term “visualization recommendation” refers to a code required to collect the plurality of datapoints for plotting visual representation that is most suitable for presenting the analyzed structured data. In this regard, the code is used by a third-party library, such as e-charts, to generate visualizations of the generated plurality of datapoints of the analyzed structured data. Typically, the visualization recommendation is based on the nature and characteristics of the generated plurality of datapoints of the analyzed structured data. Notably, the processor 102 provides the visualization recommendation when the analyzed structured data comprises the plurality of datapoints, indicating a substantial dataset that can be represented in various visual formats. Subsequently, based on the analysis, the processor 102 recommends the most appropriate visualization type (for example, bar chart, line graph, scatter plot, pie chart, and the like) that effectively conveys the information contained in the generated plurality of datapoints. Advantageously, the purpose of generating the visualization recommendation is to enable the user to interpret and understand large datasets more easily. The visualization recommendation ensures that the analyzed structured data is presented in the most meaningful and comprehensible way, facilitating better decision-making and analysis of the data by the user.

In an implementation, the processor 102 is further configured to determine the visualization recommendation based on the generated plurality of datapoints, wherein the visualization recommendation comprises at least one of a graphical representation, a pictorial representation, a combination of alpha-numeric and special characters. Herein, the term “graphical representation” refers to a type of visualization that is used to present the generated plurality of datapoints in a format that leverages graphical elements such as shapes, lines and colors to convey the analyzed structured data. Notably, the graphical representation is designed to make the analyzed structured data more comprehensible and accessible by visually illustrating relationships, patterns, and trends within the generated plurality of datapoints. Moreover, the graphical representation may include various charts and graphs, such as bar charts, line graphs, pie charts, histograms, scatter plots, area charts and the like. The term “pictorial representation” refers to a type of visualization that uses images, icons, or other pictorial elements to represent the generated plurality of datapoints of the analyzed structured data. Typically, the pictorial representation may include infographics, icon-based charts, pictograms and diagrams that use pictures to illustrate the generated plurality of datapoints. Notably, the purpose of the pictorial representation is to make the generated plurality of datapoints of the analyzed structured data more engaging and easier to comprehend by using familiar images. The pictorial representation is more visually appealing and engaging, capturing the user's attention more effectively than abstract graphs or charts. The term “combination of alpha-numeric and special characters” refers to use of letters (alphabetic characters), numbers (numeric characters), and special symbols (such as punctuation marks, mathematical symbols, or other non-alphanumeric characters) together to represent the generated plurality of datapoints of the analyzed structured data in a visual or textual format. Typically, the combination of alpha-numeric and special characters involves integration of different types of characters to form visual annotations that helps to convey the data insights. Advantageously, the combination of alpha-numeric and special characters in visualization recommendations allows for precise and detailed representation of the generated plurality of datapoints, especially in complex datasets where specific identifiers are necessary. Moreover, the processor 102 analyzes the generated plurality of datapoints to identify where and how the combination of alpha-numeric and special characters can be used most effectively.

Based on the nature of the generated plurality of datapoints and the visualization context, the processor 102 generates the visualization recommendation that includes visual elements formed by the at least one of: the graphical, the pictorial, or the combination of alpha-numeric and special characters, tailored to enhance data interpretation and presentation. Furthermore, different data types and the user needs require different visualization recommendations and providing multiple forms of visualization recommendations ensures that the processor 102 is able to meet the diverse user needs. A technical effect is that by providing tailored visualization recommendations, the processor 102 ensures that user receives the most comprehensible and useful data presentation, enhancing the overall experience.

In an implementation, the processor comprises a Large Language Model (LLM) configured to: generate the structured data query corresponding to the at least partially unstructured data query; and generate the visualization recommendation based on the plurality of datapoints. Herein, the term “Large Language Model” refers to a form of artificial intelligence model which is designed to process, understand, and generate human language. It may be appreciated that any conventional Large Language Models, known to a person skilled in the art, may be used to in the present disclosure. Notably, the LLM is capable of learning patterns, structures and nuances of the human language which enables the LLM to develop an advanced understanding of the human language and generate logical text in the form of human language. It will be appreciated that the LLM relies on use of deep learning techniques such as use of transformers that excels in understanding long-range dependencies in any sequence of data, and hence make the LLM more equipped for an advanced processing, understanding and generation of the human language. The LLM generates the structured data query corresponding to the at least partially unstructured data query, and subsequently, generates the visualization recommendation based on the plurality of datapoints. Moreover, the user often provides queries in the natural language and the LLM interprets the at least partially unstructured queries and converts the said queries into structured data queries suitable for database operations. Furthermore, once the structured data query is executed, and the resulting generated plurality of datapoints are obtained, the LLM analyzes the generated plurality of datapoints. Based on the analysis, the LLM generates the visualization recommendation for the most suitable visualization type (for example, graphical representation, pictorial representations and combination of alpha-numeric and special characters). A technical effect is that the LLM automates the process of structured data query generation and visualization recommendation, reducing the need for manual intervention and speeding up the process of generating visualizations by saving time and efforts for the user. Additionally, the LLM also enables the user to validate the visualization recommendation generated by the structured data query for the at least partially unstructured query.

In an implementation, the user device 104 comprises a user interface configured to: provide the at least partially unstructured data query; and receive the generated visualization recommendation. Herein, the term “user interface” refers to a computer-generated interface that is rendered on the user device 104 to allow the user to provide the at least partially unstructured data query in the natural language. Notably, the user device 104 also receives the generated visualization recommendation via the user interface, using graphical elements (such as icons, button, images, and the like) displayed on respective display screens of the user device 104. Typically, the UI allows the user to interact with the user device 104, by manipulating the graphical elements on the display screens of the plurality of user device 104. Moreover, the UI enables the user to collect information about how the generated visualization recommendation is presented on the user device 104 for the user. Advantageously, the UI acts as an intermediary between the user and the processor 102, simplifies the process of putting the at least partially unstructured data query and understands the generated visualization recommendation. Furthermore, the UI accepts the at least partially unstructured data query in the form of a text box where the user types the at least partially unstructured data query on a touchpad or a voice input feature where the user speaks out to the UI the at least partially unstructured data query. Once the processor 102 processes the user's query and generates the visualization recommendation, the UI displays the visualizations to the user on the user device 104. A technical effect is that the user is able to easily input the queries in natural language, making the system accessible to a broader audience, including the users unfamiliar with technical querying languages.

Throughout the present disclosure, the term “single datapoint” refers to a singular piece of data or a single record resulting from the execution of the structured data query. Notably, the analyzed structured data consists of only one specific value of data such as a total count thereof, an average thereof, and the like. Moreover, the processor 102 employs the LLM to analyze the structured data. The LLM uses the at least one statistical principle to determine whether the analyzed structured data comprises single datapoint. If the analyzed structured data has single datapoint, then no visualization is recommended for the single datapoint.

In an implementation, the processor 102 is further configured to notify the user, at the user device 104, when the analyzed structured data comprises a single datapoint prior to generating the at least one alternative structured data query corresponding to the at least partially unstructured data query. Herein, the processor notifies the user by sending a visual or auditory notification on the user device 104 that draws the user's attention to a specific condition. In this regard, the notification is used to communicate the condition that the analyzed structured data contains only a single datapoint. It will be appreciated that the notification can be delivered through various means such as a pop-up message, an email, an in-app alert (haptic, visual and/or audio), or any other form of communication supported by the user device 104. Beneficially, the notification contributes to improved user engagement, by notifying the user about the condition of the analyzed structured data and the user aware of the said situation before the processor 102 attempts to generate the alternative structured data query.

Herein, the term “alternative structured data query” refers to a different structured data query that is generated when the analyzed structured data query generates a single datapoint. Notably, the alternative structured data query is generated corresponding to the at least one of: the at least partially unstructured data query and the generated structured data query, when the initial query (either the at least partially unstructured data query or the generated structured data query) is unable to produce sufficient datapoints for meaningful analysis or the visualization recommendation. Moreover, the processor 102 evaluates the analyzed structured data, whether the analyzed structured data comprises the single datapoint. If the evaluation indicates that the datapoint is insufficient or not useful to generate visualizations, the processor 102 generates the alternative structured data query. It will be appreciated that the alternative data query may adjust parameters, expand the scope, or modify the criteria to retrieve more datapoints. Furthermore, the at least partially unstructured data query, structured data query and the alternative structured data query are related to each other and the relationship there between is iterative and adaptive, allowing the processor 102 to continuously refine data retrieval. In this regard, the at least partially unstructured data query originates from the user's natural language input, capturing the user's intent in a flexible, intuitive form. The at least partially unstructured data query is then converted into the structured data query, which formalizes the user's input into a format that can be executed against a data repository 106. If the results of the structured query are insufficient, incomplete, or provide only a single datapoint, the processor 102 generates an alternative structured data query, which serves as a refined version of the original query. The reason for generation of the alternative structured data query is that the at least partially unstructured data query and the structured data query is unable to provide sufficient datapoints for the visualization recommendation. Furthermore, the at least one statistical principle is applied to analyze the dataset generated by the structured data query. The iterative process ensures that the processor 102 can adaptively retrieve more relevant and comprehensive structured data comprising a plurality of datapoints, increasing the likelihood of providing the user with meaningful insights and visualizations. Furthermore, each query type is interconnected, with the system 100 continually refining the data retrieval process based on the results of prior queries.

In an implementation, the structured data query and the alternative structured data query is a SQL query. Herein, the term “SQL query” refers to a query or a statement written in Structured Query language (SQL) that is used to interact with a database. Typically, the SQL query generated by the processor 102 is based on the at least partially unstructured data query input by the user. Notably, the SQL query provides a powerful, efficient, and standardized way to perform complex queries. It will be appreciated that by using the SQL query for both the structured data query and the alternative structured data query, the processor 102 leverages robustness, flexibility, and widespread adoption of the SQL query to effectively retrieve and manipulate data. A technical effect is that the SQL query is optimized for querying large datasets and handling complex queries, enabling efficient and quick data retrieval.

In an implementation, the at least one alternative structured data query is generated based on at least one relevant column and/or at least one relevant row of a given structured document from amongst the multiple structured documents. Herein, the term “given structured document” refers to a specific document from the collection of multiple structured documents that contains organized data in a predefined format such as tables in the database, spreadsheets and the like. Typically, the given structured document organizes data in a structured format, comprising rows and columns where the data is systematically arranged for easy querying and analysis. Notably, the given structured document allows narrowing down the data scope for generating the alternative structured data queries, ensuring precision and relevance in the query results. Herein, the term “relevant column” refers to a specific vertical section in the given structured document that contains data pertinent to the user's query or the criteria used to generate the at least one alternative structured data query. The term “relevant row” refers to a specific horizontal section in the given structured document that contains data pertinent to the user's query or the criteria used to generate the at least one alternative structured data query. Notably, the at least one relevant column and/or the at least one relevant row is selected to include data that is crucial for generating accurate and meaningful queries, based on the user's query. Moreover, the processor 102 selects the given structured document amongst the multiple structured documents based on relevance criteria, such as, the context of the user's at least partially unstructured data query, or the nature of data being queried. Once the given structured document is identified, the processor 102 examines the at least one column and/or at least one relevant row within the given structured document to generate alternative structured data queries. For example, if the structured data query is about sales data, columns such as “Date”, “Sales Amount”, and “Product Category” might be considered relevant. Similarly, for example, if the query specifies a particular time period, rows corresponding to the particular time period would be considered relevant. Thereafter, the processor 102 generates the at least one alternative structured data query using the at least one relevant column and/or the at least one relevant row to ensure that the data retrieved is precise and relevant to the user's needs. A technical effect is that the processor 102 operates more efficiently by not having to process the entire dataset but only the given structured document, which speeds up the data retrieval and processing for the generation of the at least one alternative structured data query.

Throughout the present disclosure, the term “alternative structured data” refers to an alternative structured data that is generated as a result of executing the at least one alternative structured data query. In other words, the alternative structured data is generated corresponding to the at least one alternative structured data query. Notably, the alternative structured data adheres to a specific schema, enabling it to be easily queried, processed and analyzed corresponding to the at least one alternative structured data query. Moreover, the alternative structured data is generated similarly to the structured data but is derived from the at least one alternative structured query that was generated to provide additional information. Furthermore, the alternative structured data comprises one or more datapoints that are relevant to the user's at least partially unstructured query or to the at least one alternative structured query. Furthermore, the purpose of generating and executing the at least one alternative structured data query is to ensure that the processor 102 is able to provide accurate and relevant data even if the structured query is unable to yield sufficient or correct results. Optionally, the analyzed alternative structured data in the second iteration comprises a single datapoint that are relevant to the user's at least partially unstructured query or to the at least one alternative structured query but unable to generate visualization recommendation based on the generated one datapoint by the processor 102. Subsequently, the processor 102 performs the next iteration to generate an alternative structured data query and the processor 102 may repeat the iteration till the analyzed alternative structured data comprises the plurality of datapoints, which helps to generate a recommendation based on the generated plurality of datapoints of the alternative structure data. It may be appreciated that the number of iterations may be predetermined, such as for example 2-10 reiterations for generating a plurality of alternative structured queries. Optionally, the plurality of alternative structured queries are generated until the user aborts the process of visualization recommendation.

The LLM analyses the alternative structured data using the at least one statistical principle. It will be appreciated that the LLM employs the Edward Tufte's principle of graphical integrity for the analysis of the alternative structured data. Moreover, the alternative structured data is analyzed to ensure that the alternative structured data is not just presented the raw information but is processed to extract actionable insights. Furthermore, the at least one statistical principle can highlight any anomalies or errors in the alternative structured data, allowing for corrections and ensuring higher data quality.

In case of the at least one alternative structured data query, the term “visualization recommendation” refers to a code required to collect the plurality of datapoints for plotting visual representation that is most suitable for presenting the analyzed alternative structured data. Typically, the visualization recommendation is based on the nature and characteristics of the generated plurality of datapoints of the analyzed alternative structured data. It may be appreciated that the visualization recommendation of the analyzed alternative structured data as used herein is different from the visualization recommendation of the analyzed structured data, since that datapoints in both cases are different. Moreover, when the processor 102 analyzes that the alternative structured data contains plurality of datapoints, the processor 102 generates the visual recommendation for visualizing the plurality of datapoints of the alternative structured data. Furthermore, the visualization recommendation may include different types of visual representations such as charts, graphs, and the like visual aids to make the plurality of datapoints of the alternative structured data more understandable. Furthermore, the purpose of generating the visualization recommendation is to help the user to quickly and effectively interpret the analyzed alternative structured data. When dealing with the plurality of datapoints, it can be challenging to grasp the overall trends, patterns, or insights by just looking at the alternative structured data. The visualizations make complex alternative structured data more accessible and easier to understand. Alternatively, if the analyzed alternative structured data comprises a single datapoint, then the processor 102 can provide the visual recommendation for the single datapoint. However, in an embodiment, if the analyzed alternative structured data comprises a single datapoint, then the processor 102 is configured to terminate the data visualization process, namely the visualization recommendation and display thereof on the user interface, and notify user that the requested data visualization process can not be completed due to the single datapoint generated using the alternative structured data.

In an implementation, the system 100 further comprises a data repository 106, communicably coupled to the processor 102, configured to store therein at least one of: the at least partially unstructured data query, the structured data query, the structured data, the alternative structured data query, the alternative structured data, at least one visualization recommendation. Herein, the term “data repository” refers to a centralized storage system within the system architecture where various forms of data are systematically stored, organized, and managed. Typically, the data repository 106 is wired or wirelessly connected to the processor 102, enabling the storage and retrieval of the different types of data involved in the system's operation. Notably, the data repository 106 is used to store the data such as the at least partially unstructured data query, the structured data query, the structured data, the alternative structured data query, the alternative structured data, the at least one visualization recommendation. Moreover, the data repository 106 ensures that data is securely saved, easily accessible, and systematically organized for retrieval by the processor 102 whenever needed. Furthermore, the data repository 106 is communicably coupled to the processor 102, thereby allowing for real-time data exchange therebetween. When the system 100 receives a query or generates a data output, it can store this information in the data repository 106. The processor 102 can then access and manipulate the data as needed, whether for executing queries, generating alternative queries, analyzing data, or recommending visualizations. A technical effect of using the data repository 106 is to ensure that all relevant data (such as queries, results, visualization recommendation and the like) is stored in a consistent and secure manner, allowing the processor 102 to maintain record of the operations performed by the processor 102. Additionally, quick access to previously stored data, can streamline the process of generating new queries or visualizations based on existing information.

Moreover, the processor 102 displays the visualization recommendation for the analyzed alternative structured data directly to user on the user device 104. Furthermore, the visualization recommendation is displayed to the user in a manner that is accessible and understandable to the user. Furthermore, the purpose of representing is to ensure that the user is able to view, interact with, and utilize the visual representation of the analyzed alternative structured data. The processor 102, after recommending the visualization, displays the visualizations on the user device 104 via the user interface. The user is able to view the visualizations and, depending on the system's capabilities, may interact with the visualizations (e.g., zooming in, changing the type of visualization, exploring different datapoints). Furthermore, direct representation of the visualizations allows the users to quickly gain insights from the analyzed alternative structured data without the need for additional steps or external tools, thus speeding up the decision-making process.

In an implementation, the processor 102 is further configured to extract metadata from the visualization recommendation, and wherein the metadata is adapted to be used in a third-party library for a subsequent processing of the plurality of datapoints. Herein, the term “third-party library” refers to an external collection of pre-written code, functions, or software modules developed by a different organization other than the primary developer of the system. Typically, the third-party library (like Apache E-Charts) is integrated with the processor 102 to provide additional functionality, such as data processing, visualization, machine learning, or other specialized operations, without needing to develop the said capabilities from scratch. The term “metadata” refers to a data that can be substituted in the third-party library by the processor 102. Notably, the metadata may include x-axis values, y-axis values of the graphical representation, titles labels and the like. Moreover, the metadata extracted from the visualization recommendation is designed to be compatible with or specifically formatted for use within the third-party library. Furthermore, the subsequent processing of the plurality of datapoints may include further analysis of the plurality of datapoints, manipulation or visualizations that the third-party library is specifically designed to handle. Furthermore, the purpose of the subsequent processing of the plurality of datapoints enable further, possibly more specialized or advanced, processing of the datapoints beyond what the system natively provides and enhances the system's flexibility and extensibility, allowing the system to integrate with a broader ecosystem of tools and technologies. Furthermore, the processor 102 is designed with functionality that not only generates the visualization recommendation but also understands how to break down the visualization recommendation into the metadata. A technical effect of the subsequent processing of data using third-party libraries can lead to more sophisticated insights, optimizations, or visualizations. For example, a third-party library might offer advanced machine learning models, graphing capabilities, or statistical tools that are not natively available in the system, thus allowing the user to achieve more detailed or accurate visualization recommendation results.

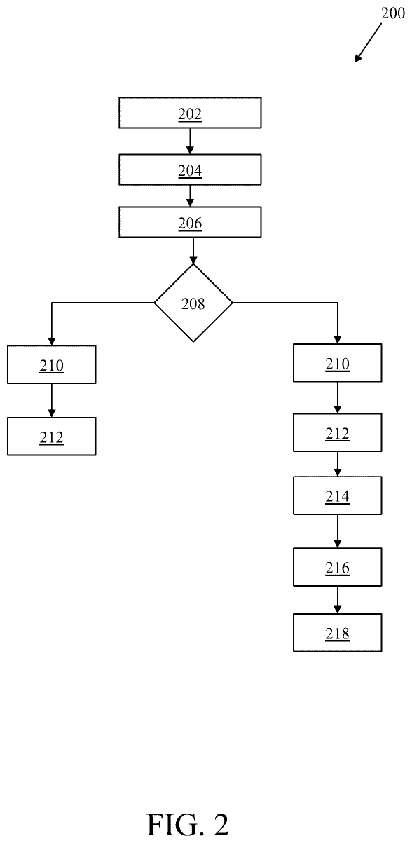

FIG. 2 is a flowchart of a method for generating visualizations from structured data queried through natural language in accordance with an embodiment of the present disclosure. The method 200 comprises steps from 202 to 218. At step 202, the at least partially unstructured data query is received, and a corresponding structured data query is generated thereto. At step 204, the generated structured data query is executed to generate structured data comprising one or more datapoints. At step 206, the structured data is received, and the structured data is analyzed according to at least one statistical principle. At step 210, a visualization recommendation based on the generated plurality of datapoints is generated when at step 208, the analyzed structured data comprises a plurality of datapoints. At step 208, when the analyzed structured data comprises a single datapoint, at step 210, at least one alternative structured data query corresponding to the at least one of: at least partially unstructured data query, the structured data query is generated. At step 212, the generated at least one alternative structured data query is executed to generate a corresponding alternative structured data comprising one or more datapoints. At step 214, the alternative structured data is analyzed according to at least one statistical principle. At step 216, a visualization recommendation based on the generated plurality of datapoints is generated, when the analyzed alternative structured data comprises a plurality of datapoints. At step 218, the generated visualization recommendation to the user is presented at the user device.

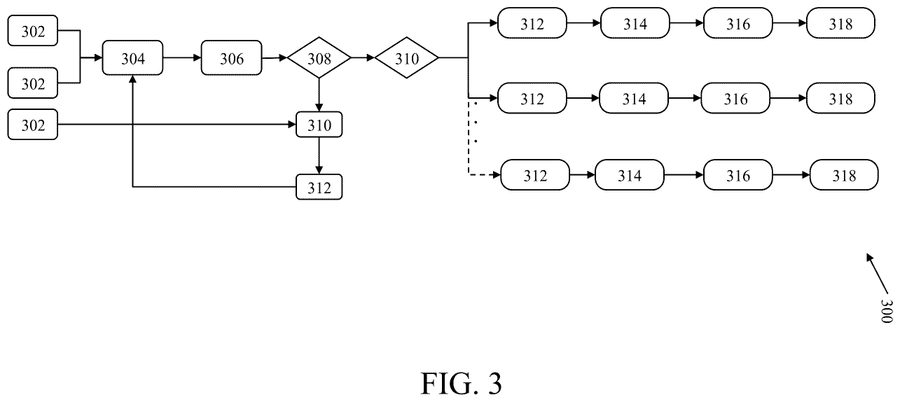

FIG. 3 is a flowchart depicting an exemplary scenario of a system for generating visualizations from structured data queried through natural language, in accordance with an embodiment of the present disclosure. At step 302, at least partially unstructured data query is input by the user or data aggregated from a corresponding data aggregation tool is provided. At step 304, the at least statistical principle is applied, and visualization recommendation is generated. At step 306, the visualization is validated and matplotlib code is generated for the visualization recommendation. At step 308, the processor checked for no visualization recommendation. If the visualization recommendation is present, then, at step 310, the processor selects the script to identify the type of the visual recommendation and subsequently at step 312, extract codes for the collection of the plurality of datapoints. At step 314, the extracted codes are executed and the plurality of datapoints are collected. At step 316, the plurality of datapoints is slot filled in the e-chart code for the graphical representation. At step 318, the updated codes are returned to the processor with actual plurality of datapoints. Optionally, at step 308, if no visualization is recommended, then at step 310, alternative data query is generated. At step 312, the alternative structured data query is executed on a data aggregation tool to collect the alternative structured data, and the alternative structured data is sent at step 304, where the at least statistical principle is applied, and visualization recommendation is generated for the alternative structured data.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A system (100) for generating visualizations from structured data queried through natural language, the system comprising processor (102) communicably coupled to a user device (104), the processor configured to:
receive at least partially unstructured data query from the user device and generate a corresponding structured data query thereto;
execute the generated structured data query to generate structured data comprising one or more datapoints;
receive the structured data and analyze the structured data according to at least one statistical principle;
when the analyzed structured data comprises a plurality of datapoints, generate a visualization recommendation based on the generated plurality of datapoints; or
when the analyzed structured data comprises a single datapoint,
generate at least one alternative structured data query corresponding to the at least one of: at least partially unstructured data query, the structured data query,
execute the generated at least one alternative structured data query to generate a corresponding alternative structured data comprising one or more datapoints,
analyze the alternative structured data according to at least one statistical principle, and
when the analyzed alternative structured data comprises a plurality of datapoints, generate a visualization recommendation based on the generated plurality of datapoints; and
present, at the user device, the generated visualization recommendation to the user.

2. The system (100) of claim 1, wherein the at least partially unstructured data query is a user query in natural language.

3. The system (100) of claim 1, further comprising a data repository (106), communicably coupled to the processor (102), configured to store therein at least one of:
the at least partially unstructured data query, the structured data query, the structured data, the alternative structured data query, the alternative structured data, at least one visualization recommendation.

4. The system (100) of claim 1, wherein the user device (104) comprises a user interface configured to:
provide the at least partially unstructured data query; and
receive the generated visualization recommendation.

5. The system (100) of claim 1, wherein the structured data query and the alternative structured data query is a SQL query.

6. The system (100) of claim 1, wherein the processor (102) comprises a Large Language Model (LLM) configured to:
generate the structured data query corresponding to the at least partially unstructured data query; and
generate the visualization recommendation based on the plurality of datapoints.

7. The system (100) of claim 1, wherein the processor (102) is further configured to determine the visualization recommendation based on the generated plurality of datapoints, wherein the visualization recommendation comprises at least one of a graphical representation, a pictorial representation, a combination of alpha-numeric and special characters.

8. The system (100) of claim 1, wherein the at least partially unstructured data query is implemented as multiple structured documents.

9. The system (100) of claim 1, wherein the at least one alternative structured data query is generated based on at least one relevant column and/or at least one relevant row of a given structured document from amongst the multiple structured documents.

10. The system (100) of claim 1, wherein the processor (102) is further configured to notify the user, at the user device (104), when the analyzed structured data comprises a single datapoint prior to generating the at least one alternative structured data query corresponding to the at least partially unstructured data query.

11. The system (100) of claim 1, wherein the processor (102) is further configured to extract metadata from the visualization recommendation, and wherein the metadata is adapted to be used in a third-party library for a subsequent processing of the plurality of datapoints.

12. A method for generating visualizations from structured data queried through natural language, the method comprising:
receiving at least partially unstructured data query and generating a corresponding structured data query thereto;
executing the generated structured data query to generate structured data comprising one or more datapoints;
receiving the structured data and analyze the structured data according to at least one statistical principle;
when the analyzed structured data comprises a plurality of datapoints, generating a visualization recommendation based on the generated plurality of datapoints; or
when the analyzed structured data comprises a single datapoint,
generating at least one alternative structured data query corresponding to the at least one of: at least partially unstructured data query, the structured data query,
executing the generated at least one alternative structured data query to generate a corresponding alternative structured data comprising one or more datapoints,
analyzing the alternative structured data according to at least one statistical principle, and
when the analyzed alternative structured data comprises a plurality of datapoints, generating a visualization recommendation based on the generated plurality of datapoints; and
presenting, at the user device, the generated visualization recommendation to the user.

13. The method of claim 12, further comprising storing, in a data repository (106), at least one of: the at least partially unstructured data query, the structured data query, the structured data, the alternative structured data query, the alternative structured data, at least one visualization recommendation.

14. The method of claim 12, further comprising:
providing the at least partially unstructured data query; and
receiving the generated visualization recommendation.

15. The method of claim 12, wherein the method employs a Large Language Model (LLM) for:
generating the structured data query corresponding to the at least partially unstructured data query; and
generating the visualization recommendation based on the plurality of datapoints.

16. The method of claim 12, further comprising determining the visualization recommendation based on the generated plurality of datapoints, wherein the visualization recommendation comprises at least one of a graphical representation, a pictorial representation, a combination of alpha-numeric and special characters.

17. The method of claim 12, wherein the method comprises generating the at least one alternative structured data query based on at least one relevant column and/or at least one relevant row of a given structured document from amongst multiple structured documents associated with the at least partially unstructured data query.

18. The method of claim 12, further comprising notifying the user when the analyzed structured data comprises a single datapoint prior to generating the at least one alternative structured data query corresponding to the at least partially unstructured data query.

19. The method of claim 12, further comprising extracting metadata from the visualization recommendation, and wherein the metadata is adapted to be used in a third-party library for a subsequent processing of the plurality of datapoints.

20. A non-transitory computer-readable storage medium having computer-readable instructions stored thereon, the computer-readable instructions being executable by a processor (102) to execute a method of claim 12.
